(19) United States
(12) Patent Application Publication
(10) Pub. No.: US 2008/0240772 A1
(43) Pub. Date: Oct. 2, 2008

(54) TONER CARTRIDGE, TONER REFILLING METHOD AND IMAGE FORMING APPARATUS USING THE TONER CARTRIDGE

(75) Inventor: Yoshiyuki Nishikawa, Osaka-shi (JP)

Correspondence Address: CASELLA & HESPOS, 274 MADISON AVENUE, NEW YORK, NY, 10016, US

(73) Assignee: KYOCERA MITA CORPORATION, Osaka-shi (JP)

(21) Appl. No.: 12/056,329

(22) Filed: Mar. 27, 2008

(30) Foreign Application Priority Data
Mar. 28, 2007 (JP) 2007-085604

(51) Int. Cl. G03G 15/08

(52) U.S. Cl. 399/106

(57) ABSTRACT

A toner cartridge (20) includes a main cartridge body (30) having a housing formed with an opening (350) and also having a rotary shaft (41) supported by the housing for rotation about an axis thereof, a detachable member (60) mounted to the opening (350) and having a toner outlet (610) through which the toner (T) is discharged and a sealing film (70) having a first end so attached to the detachable member (60) as to close the toner outlet (610) and a second end attached to a part of the main cartridge body (30), the first end of the sealing film (70) being peeled off from the detachable member (60) by the rotation of the rotary shaft (41).

### BACKGROUND OF THE INVENTION

1. Field of the Invention

The present invention relates to a toner cartridge which is detachably mounted in an image forming apparatus for supplying toner to a developing unit thereof as well as to a method of refilling a used toner cartridge with toner. The present invention also relates to an image forming apparatus using the toner cartridge.

2. Description of the Related Art

A toner cartridge is detachably mounted in an image forming apparatus such as a copying machine, a printer or a facsimile machine and supplies toner to a developing unit of the image forming apparatus. The toner cartridge has a toner outlet through which the toner is discharged. The toner outlet of the toner cartridge is initially (at the time of delivery) sealed by a seal member attached thereto.

The seal member is removed when the toner cartridge is mounted in the image forming apparatus. At this time, toner particles adhering to the seal member tend to scatter in internal and external spaces of the image forming apparatus.

Arrangements directed to solve this toner scattering problem are described in, for example, the JP Laid-open Patent Publications No. 03-221981 and No. 06-202467 (hereinafter referred to as “Patent Publication 1” and “Patent Publication 2”, respectively) in which a toner cartridge (referred to as a “toner hopper” in Patent Publication 1) is provided with a built-in toner-stirring rotary shaft which winds up a seal member sealing an toner outlet when rotated. According to the arrangements of Patent Publications 1 and 2, it is not necessary to peel off the seal member before mounting the toner cartridge into the image forming apparatus, so that the toner outlet can be held closed prior to the mounting of the toner cartridge into the image forming apparatus. This makes it possible to prevent the toner scattering.

Used toner cartridges are often recycled for effective use of industrial materials and environmental protection. The toner cartridges described in Patent Publications 1 and 2 are recyclable except for the seal member after toner in the toner cartridge has been used up. Accordingly, it is possible to reuse the toner cartridge if the cartridge is refilled with toner and the toner outlet is sealed by a new seal member.

In the toner cartridges described in the Patent Publications 1 and 2, however, the seal member is attached to the inside of the toner cartridge and, thus, it is extremely difficult to replace the seal member with a new one and, in practice, the seal member can not be replaced unless the toner cartridge is disassembled. For this reason, the toner cartridge of this kind has not ever been recycled in industrially practicable manner.

### SUMMARY OF THE INVENTION

In view of the above circumstances, it is an object of the present invention to provide a toner cartridge which can be easily reassembled to original state and a method of refilling a used toner cartridge with toner in order to permit the recycling of the toner cartridge.

To achieve the aforementioned object, a toner cartridge filled with toner includes a main cartridge body having a housing formed with an opening and a rotary shaft supported by the housing for rotation about an axis thereof. The toner cartridge also includes a detachable member mounted to the opening and having a toner outlet through which the toner is discharged, and a sealing film having a first end so attached to the detachable member as to close the toner outlet and a second end attached to a part of the main cartridge body. The first end of the sealing film is peeled off from the detachable member by the rotation of the rotary shaft.

Also, a toner refilling method for refilling toner in the toner cartridge includes the step of detaching the detachable member from the main cartridge body, the step of removing the sealing film left in the main cartridge body through the opening, the step of preparing a replacement detachable member to which a first end of a new sealing film is attached, the step of attaching a second end of the new sealing film to a part of the main cartridge body, the step of mounting the replacement detachable member to the main cartridge body and the step of filling the toner in the main cartridge body.

### BRIEF DESCRIPTION OF THE DRAWINGS

In any event, the present invention will become more clearly understood from the following description of preferred embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIGS. 1A and 1B are perspective external views of a printer utilizing a toner cartridge according to a preferred embodiment of the present invention, with a delivery unit mounted in a main body of the printer;

FIGS. 2A and 2B are perspective external views of the printer utilizing the toner cartridges of the preferred embodiment, with the delivery trays removed from the main body;

FIG. 3 is a cross-sectional view showing the internal construction of the main body as seen from a left side thereof;

FIG. 4 is an exploded perspective view of the toner cartridge of the preferred embodiment;

FIG. 5 is a perspective view of the toner cartridge in an assembled state;

FIG. 6 is a cross-sectional view taken along the line VI-VI of FIG. 5;

FIGS. 7A and 7B are cross-sectional views taken along the line VII-VII of FIG. 5, FIG. 7A showing a state in which a toner outlet of the toner cartridge is closed off by a sealing film and FIG. 7B showing a state in which the sealing film is removed from the toner outlet;

FIGS. 8A to 8E are cross-sectional views for explaining a procedure for refilling a used toner cartridge with toner, FIG. 8A showing a detachable member detaching process, FIG. 8B showing a sealing film removal process, FIG. 8C showing a sealing film attachment process, FIG. 8D showing a detachable member mounting process and FIG. 8E showing a toner filling process; and

FIGS. 9A and 9B are cross-sectional views for explaining alternative arrangements for attachment of the sealing film, FIG. 9A showing a second mode of sealing film attachment in which a second end of the sealing film is wound around a rotary shaft of a toner stirring and feeding member and FIG. 9B showing a third mode of sealing film attachment in which the second end of the sealing film is attached to a front wall of a main cartridge body.

### DETAILED DESCRIPTION OF THE PREFERRED EMBODIMENTS

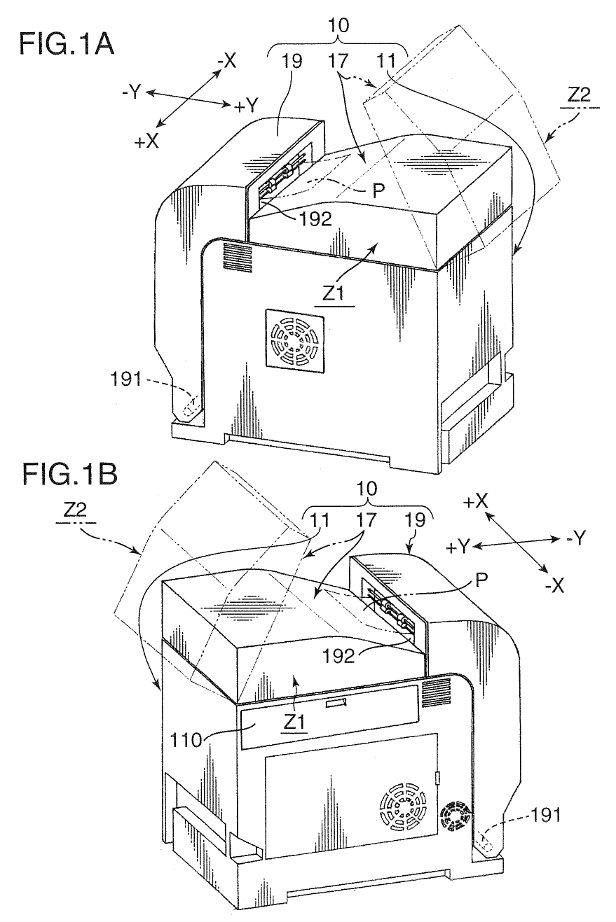

As an example of an image forming apparatus to which a toner cartridges 20 according to a preferred embodiment of the present invention is applied, a printer 10 is described with reference to FIGS. 1A to 3.

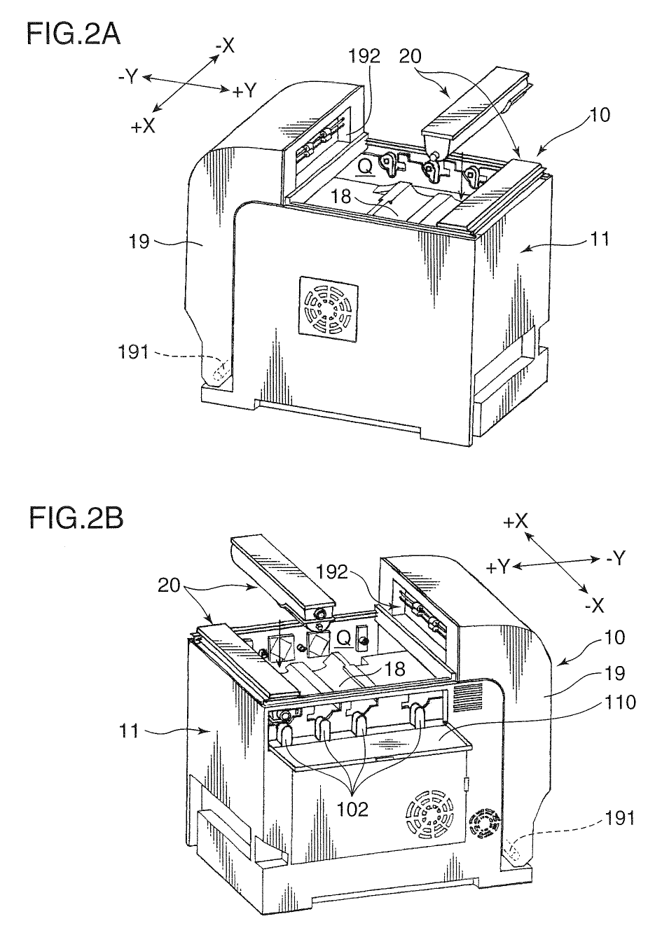

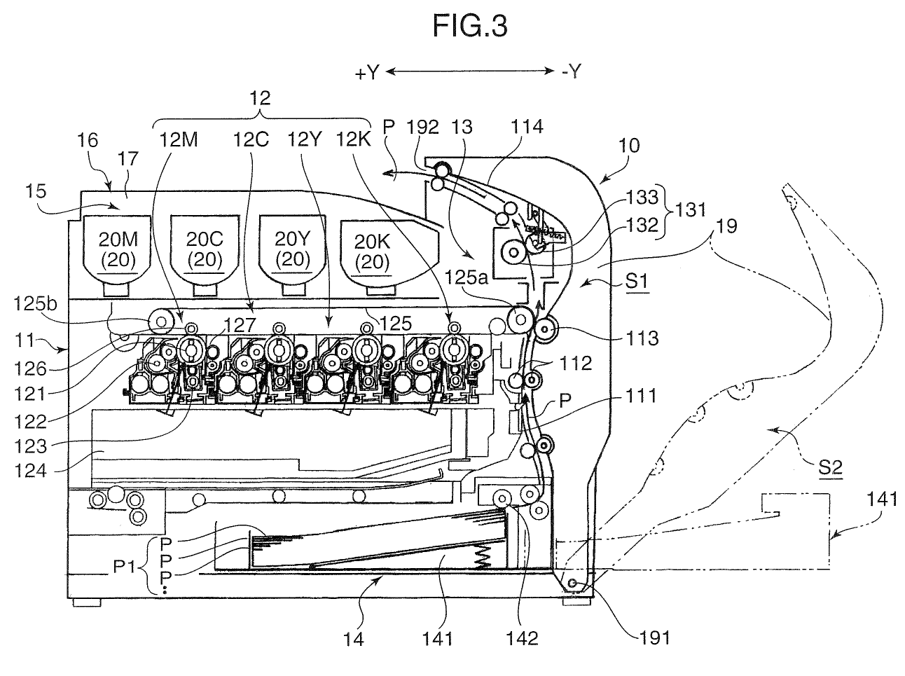

FIGS. 1A to 2B are perspective external views of the printer 10. More specifically, FIGS. 1A and 1B are perspective external views of the printer 10 of which main body 11 is fitted with a delivery tray 17, FIG. 1A showing the printer 10 as seen from a rear-right direction, FIG. 1B showing the printer 10 as seen from a rear-left direction. FIGS. 2A and 2B are perspective external views of the printer 10 with the delivery tray 17 removed from the main body 11, FIG. 2A showing the printer 10 as seen from the rear-right direction, FIG. 2B showing the printer 10 as seen from the rear-left direction. FIG. 3 is a cross-sectional view showing one example of the internal construction of the main body 11 as seen from a left side thereof. In FIGS. 1A, 1B, 2A, 2B and 3, a −X to +X axis designates left and right directions, −X indicating the left direction and +X indicating the right direction, whereas a −Y to +Y axis designates a front and rear directions, −Y indicating the front direction and +Y indicating the rear direction. It is to be noted that, as illustrated in FIGS. 1A to 2B, the left and right directions indicated by −X and +X, respectively, are inverted from actual left and right directions shown in these drawing sheets.

The printer 10 includes the main body 11 having a generally box-like structure in which various components used for image forming operation are mounted, the delivery tray 17 fitted to a top surface of the main body 11 and a cover unit 19 fitted to a front surface of the main body 11 in a manner that both the delivery tray 17 and the cover unit 19 can be opened and closed.

The delivery tray 17 receives a sheet P after the sheet P is subjected to an image forming process in the main body 11. The delivery tray 17 can be swung about a rear lower end thereof to assume between a closed position Z1 (shown by solid lines in FIGS. 1A and 1B) at which the top opening of the main body 11 is closed and an open position Z2 at which the top opening of the main body 11 is exposed (shown by alternate long and two short dashed lines in FIGS. 1A and 1B). A front half of a top surface of the delivery tray 17 is inclined forwardly downward and the sheet P ejected from a rear surface of an upper part of the cover unit 19 is guided to the top surface of the delivery tray 17 by the inclined surface of the delivery tray 17.

The delivery tray 17 is made detachable from the main body 11. As shown in FIGS. 2A and 2B, the top opening formed in the main body 11 extends rearward from the upper part of the rear surface of the cover unit 19. This top opening of the main body 11 permits removal and mounting of the toner cartridges 20 with the delivery tray 17 removed from the main body 11. Slightly beneath the top opening of the main body 11, there is provided a separation plate 18 for separating in the internal space of the main body 11 the toner cartridges 20 and an image forming unit 12 (FIG. 3) mounted below the toner cartridges 20 from each other. The toner cartridges 20 are accommodated in a cartridge compartment Q provided above the separation plate 18 as shown in FIGS. 2A and 2B.

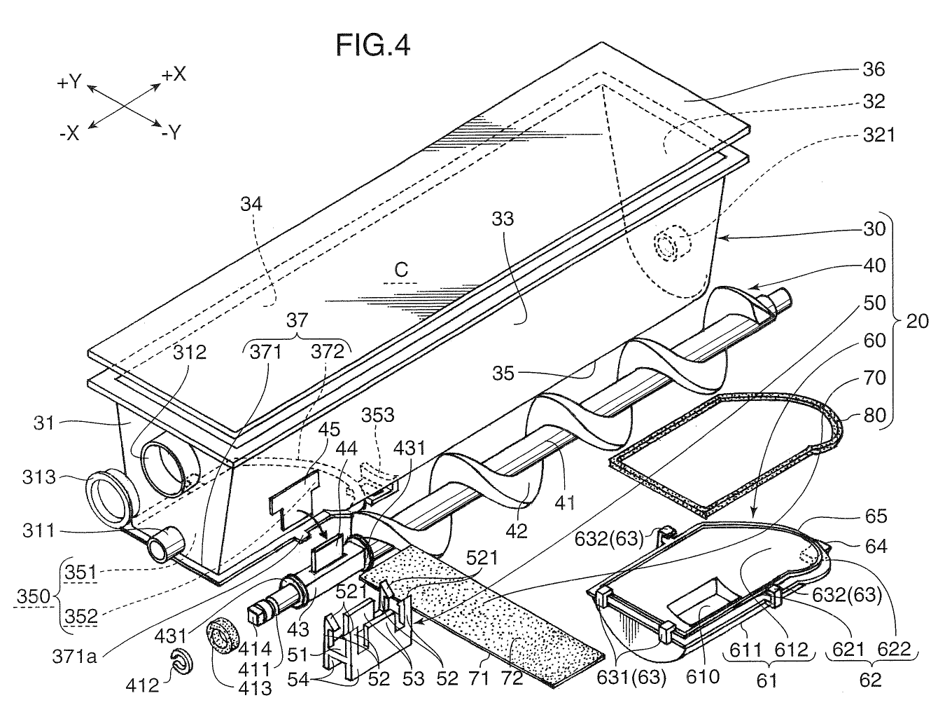

The toner cartridges 20 are detachably mounted in the cartridge compartment Q of the main body 11 while being supported by an upper surface of the separation plate 18. When mounted in the cartridge compartment Q, each of the toner cartridges 20 is positioned such that a toner outlet 610 (FIG. 4) formed in the toner cartridge 20 faces a toner receiving hole (not shown) formed in the separation plate 18. Toner in the toner cartridge 20 is supplied by a toner stirring and feeding member 40 (FIG. 4) arranged in the toner cartridge 20 to a developing unit 122 (FIG. 3) through the toner receiving hole in the separation plate 18 and a toner feeding tube (not shown).

The cover unit 19 is generally inverted L-shaped in side view (as seen from the +X direction) and the upper part of the cover unit 19 hooks onto an upper front corner of the main body 11. A lower end of the cover unit 19 is rotatably mounted on a support shaft 191 fitted in a frame of the main body 11 to move between a closed position S1 (shown by solid lines in FIG. 3) at which a front opening of the main body 11 is closed by the cover unit 19 and an open position S2 at which the front opening of the main body 11 is exposed (shown by alternate long and two short dashed lines in FIG. 3).

There is formed a sheet exit 192 in the upper part of the rear surface of the cover unit 19 through which the printed sheet P is ejected onto the delivery tray 17. The sheet P is ejected onto the delivery tray 17 from the sheet exit 192 after passing through a sheet passage defined between the front side of the main body 11 and the rear surface of the cover unit 19.

The internal construction of the main body 11 is now described with reference to FIG. 3. Inside the main body 11 of the printer 10, there are provided the image forming section 12 for forming an image based on image data fed from an external device such as a computer, a fixing section 13 for fixing a toner image which is formed by the image forming section 12 and then transferred to the sheet P, a sheet storage section 14 for storing a sheet stack of sheets P, and a toner feeding section 15 for feeding toner to the image forming section 12. At the top of the main body 11, there is provided a sheet delivery section 16 including the delivery tray 17 onto which the sheet P carrying the fixed toner image is ejected. The main body 11 is further provided with a manual operation panel through which a user can enter various settings for print job.

The image forming section 12 forms a toner image on the sheet P fed from the sheet storage section 14. In this embodiment, the image forming section 12 includes a plurality of subsections which utilize toners (developers) of different colors. These are a magenta subsection 12M for forming a magenta image with magenta toner, a cyan subsection 12C for forming a cyan image with cyan toner, a yellow subsection 12Y for forming a yellow image with yellow toner and a black subsection 12K for forming a black image with black toner, all of which are arranged in this order from an upstream side to a downstream side (left to right as illustrated in FIG. 3).

Each of the subsections 12M, 12C, 12Y, 12K includes a photosensitive drum 121 and a developing unit 122. The photosensitive drum 121 forms on an outer peripheral surface thereof an electrostatic latent image and then forms a toner image from the electrostatic latent image with toner supplied from the developing unit 122. The outer peripheral surface of the photosensitive drum 121 is formed with an extremely smooth photosensitive layer made from a photosensitive material such as amorphous silicon which is strong and highly wear-resistant. Each of the photosensitive drums 121 receive toner from the corresponding developing unit 122 while rotating clockwise. The individual developing units 122 receive the toners from the toner feeding section 15.

Immediately beneath the photosensitive drums 121, there are provided charging units 123. Further beneath the charging units 123, there are provided exposure units 124 corresponding to each of the charging units 123. The outer peripheral surface of each photosensitive drum 121 is uniformly charged by the charging unit 123. The exposure units 124 illuminate the electrostatically charged outer peripheral surfaces of the photosensitive drums 121 with laser beams of respective colors based on image data supplied from the external device such as a computer, whereby electrostatic latent images of the respective colors are formed on the outer peripheral surfaces of the photosensitive drums 121. The developing units 122 supply the toners to the respective photosensitive drums 121 to form color toner images on the outer peripheral surfaces of the photosensitive drums 121 from the electrostatic latent images.

Immediately over the photosensitive drums 121, there is provided a transfer belt 125 which is so wound around between drive roller 125a and a driven roller 125b as to be held in contact with the photosensitive drums 121. The transfer belt 125 moves between the drive roller 125a and the driven roller 125b in synchronism with the rotation of the photosensitive drums 121 while being pressed against the outer peripheral surfaces of the photosensitive drums 121 by means of respective first transfer rollers 126.

As the transfer belt 125 rotates, the magenta toner image on the photosensitive drum 121 of the magenta subsection 12M is first transferred onto an outer surface of the transfer belt 125. Subsequently, the cyan toner image on the photosensitive drum 121 of the cyan subsection 12C, the yellow toner image on the photosensitive drum 121 of the yellow subsection 12Y and, finally, the black toner image on the photosensitive drum 121 of the black subsection 12K are successively transferred onto the transfer belt 125 in this order. As a result, a full-color toner image is formed on the outer surface of the transfer belt 125 and this toner image is transferred to the sheet P fed from the sheet storage section 14.

Each of the subsections 12M, 12C, 12Y, 12K includes a cleaning unit 127 disposed at a position downstream of the photosensitive drum 121 for removing residual toner left on the outer peripheral surface of the photosensitive drum 121. Then, the outer peripheral surfaces of the photosensitive drums 121 are electrostatically charged again by the respective charging units 123.

The unused toners removed from the outer peripheral surfaces of the photosensitive drums 121 by the cleaning units 127 are collected through specific paths and then stored in toner collection bottles.

In front of the image forming section 12, there is formed a sheet feeding path 111 extending generally vertically along the rear side of the cover unit 19 to feed a sheet P. The sheet feeding path 111 is provided with a pair of transport rollers 112 which are actuated to feed the sheet P fed from the sheet storage section 14 toward the transfer belt 125.

The sheet feeding path 111 is also provided with a second transfer roller 113 which is so positioned to face the drive roller 125a while being held in contact with the outer surface of the transfer belt 125. The sheet P fed through the sheet feeding path 111 is applied a specific voltage by the second transfer roller 113 so that the toner image on the transfer belt 125 is transferred onto the sheet P.

The fixing section 13 includes a fixing device 131 which fixes the toner image transferred on the sheet P. The fixing device 131 is provided at a position immediately above the second transfer roller 113.

The fixing device 131 includes a fixing roller 132 provided with a built-in electric heating element such as a halogen lamp, and a pressing roller 133. The fixing roller 132 and the pressing roller 133 are disposed face to face with outer peripheral surfaces of the rollers 132, 133 held in contact with each other. When the fixing roller 132 is activated, the sheet P carrying the transferred toner image is passed through a nip formed between the fixing roller 132 and the pressing roller 133. As the sheet P passes through the nip, the toner image on the sheet P is fixed to the sheet P by heat supplied from the fixing roller 132. Subsequently, the sheet P carrying the fixed toner image is conveyed through a sheet ejection path 114 extending from an upper part of the fixing section 13 to the sheet exit 192 and ejected onto the delivery tray 17 of the sheet delivery section 16 through the sheet exit 192.

The sheet storage section 14 located below the exposure units 124 includes a detachably mounted sheet cassette 141. The sheet tray 141 holding a sheet stack P1 of sheets P has a box-like structure of which top side fully opens upward. A topmost one of the stacked sheets P held in the sheet tray 141 is picked up by a pickup roller 142 located at a downstream end (forward end as illustrated in FIG. 3) of the sheet tray 141 and sent into the sheet feeding path 111. The sheet P is transported by the transport roller pair 112 through the sheet feeding path 111 to a nip formed between the second transfer roller 113 and the transfer belt 125 in the image forming section 12.

The toner feeding section 15 accommodates four toner cartridges 20 corresponding to the subsections 12M, 12C, 12Y, 12K. These are a magenta toner cartridge 20M, a cyan toner cartridge 20C, a yellow toner cartridge 20Y and a black toner cartridge 20K. When the developing units 122 of the subsections 12M, 12C, 12Y, 12K become short of the toners, the toner cartridges 20M, 20C, 20Y, 20K supply the toners to the respective subsections 12M, 12C, 12Y, 12K through the toner feeding tubes.

As previously mentioned, the cover unit 19 is made swingable between the closed position S1 and the open position S2 to close and open the front side of the main body 11. The cover unit 19 is normally at the closed position S1 at which the sheet feeding path 111 for feeding the sheet P from the sheet storage section 14 to the second transfer roller 113 is formed between the front side of the image forming section 12 and the cover unit 19.

When a paper jam occurs at the transport roller pair 112 or at the fixing section 13, the cover unit 19 can be opened by swinging the same frontward from the closed position S1 to the open position S2 so that the user can expose the sheet feeding path 111 or the fixing section 13 to the outside and easily remove the jammed sheet P therefrom.

Inside the cover unit 19, there is provided a sheet reversing path used for duplex (double-sided) printing, in which the sheet P which has passed the second transfer roller 113 is reversed and returned to the sheet feeding path 111 to permit printing on a reverse side of the sheet P. The sheet reversing path is not illustrated or described in further detail.

At an upper part of the left side of the main body 11, there is provided a horizontally elongate flip-down door 110 (FIG. 1B) which can be opened when any of the toner cartridges 20 is to be removed from or installed in the main body 11. Various other maintenance jobs can be carried out with the flip-down door 110 opened as shown in FIG. 2B.

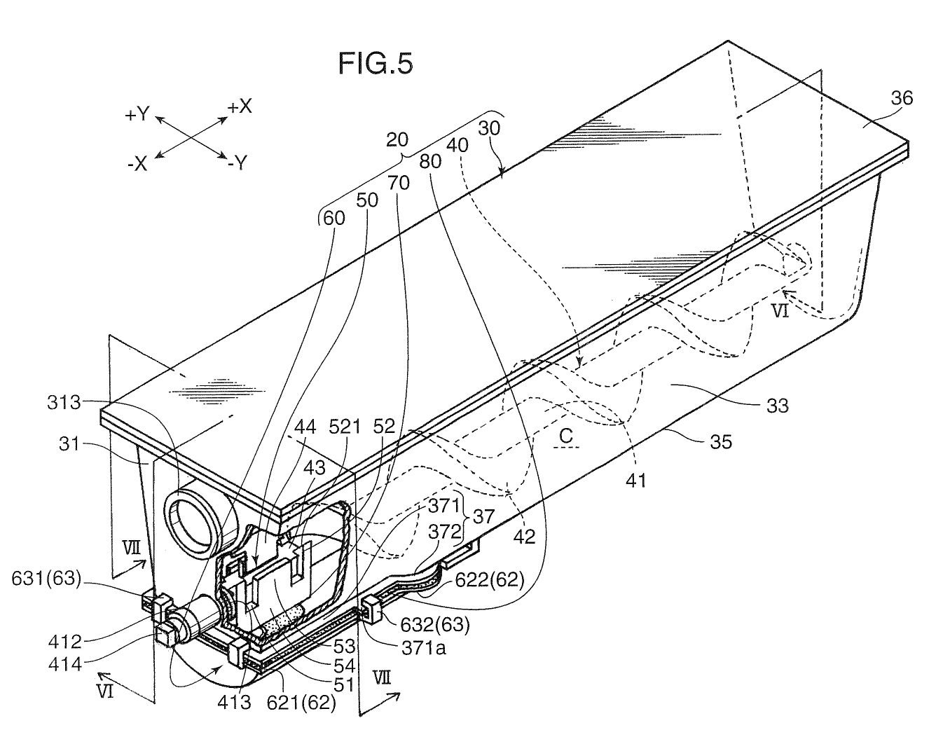

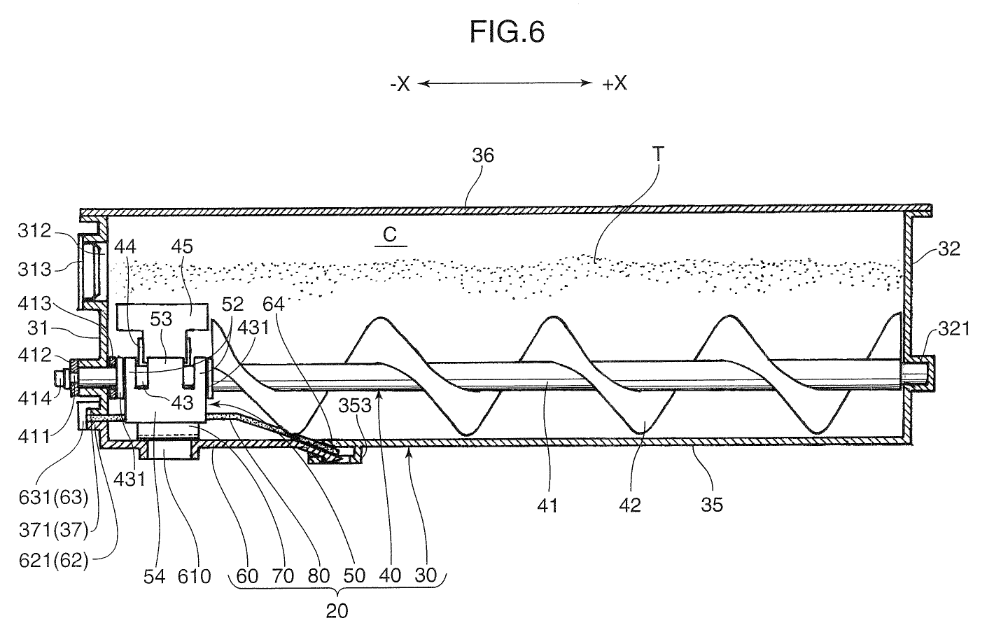

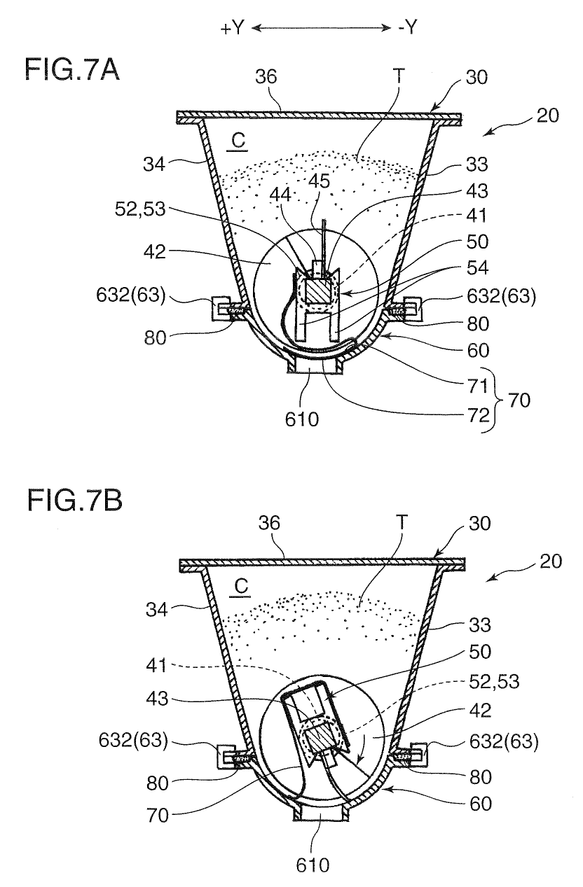

Referring now to FIGS. 4, 5, 6, 7A and 7B, the toner cartridge 20 detachably mounted in the main body 11 of the printer 10 is described in detail. FIG. 4 is an exploded perspective view of the toner cartridge 20 of the embodiment, FIG. 5 is a perspective view of the toner cartridge 20 in an assembled state, and FIG. 6 is a cross-sectional view taken along the line VI-VI of FIG. 5. FIGS. 7A and 7B are cross-sectional views taken along the line VII-VII of FIG. 5, FIG. 7A showing a state in which the toner outlet 610 of the toner cartridge 20 is closed by a sealing film 70 and FIG. 7B showing a state in which the sealing film 70 is removed to open the toner outlet 610. In these Figures, −X and +X designate the left and right directions while −Y and +Y designate the front and rear directions as in FIGS. 1A and 1B.

Referring first to FIG. 4, the toner cartridge 20 includes a main cartridge body 30 which serves as a vessel for holding inside toner T (shown by small dots in FIGS. 6, 7A and 7B), the toner stirring and feeding member 40 for transporting the toner T while stirring up the same, a joint member 50 detachably mounted on the toner stirring and feeding member 40, a detachable member 60 detachably mounted to a bottom of the main cartridge body 30 and having the toner outlet 610 formed therein, the sealing film 70 for closing off the toner outlet 610 and a seal member 80 placed between the main cartridge body 30 and the detachable member 60.

The main cartridge body 30 has a generally rectangular parallelepiped box-like structure which is elongate along the left and right directions. The main cartridge body 30 includes a housing made of a left-side wall 31, a right-side wall 32 facing the left-side wall 31, a front wall 33 interconnecting front ends of the left- and right-side walls 31, 32, a rear wall 34 interconnecting rear ends of the left- and right-side walls 31, 32, and a semicylindrical bottom 35 having a downwardly protruding arc-shaped cross section as seen along the left and right directions. The detachable member 60 forms a part of the bottom 35 of the main cartridge body 30.

The main cartridge body 30 has a top opening which is closed off by a rectangular top plate 36 which is attached to the top of the main cartridge body 30. The inside space of the main cartridge body 30 bounded by the left-side wall 31, the right-side wall 32, the front wall 33, the rear wall 34, the semicylindrical bottom 35 and the top plate 36 constitutes a toner compartment C for storing the toner T.

The bottom 35 is formed with a mounting opening 350 at a left end portion thereof. The detachable member 60 is mounted to the mounting opening 350. The mounting opening 350 includes a horizontal opening portion 351 formed by cutting a lower portion of the main cartridge body 30 straight (horizontally) rightward from the left-side wall 31 and a slant opening portion 352 formed by cutting the lower portion of the main cartridge body 30 obliquely downward further rightward from the horizontal opening portion 351.

The bottom opening 350 in the semicylindrical bottom 35 is bounded by a main cartridge body-side flange 37 which extends outward from the semicylindrical bottom 35. The main cartridge body-side flange 37 is made up of a horizontal flange portion 371 formed along the horizontal opening portion 351 and a slant flange portion 372 formed along the slant opening portion 352.

The left-side wall 31 of the main cartridge body 30 is formed at a location corresponding to the center of curvature of the semicylindrical bottom 35 with a left-side shaft supporting sleeve 311 for supporting a left end of a rotary shaft 41 of the toner stirring and feeding member 40. Also, the right-side wall 32 of the main cartridge body 30 is formed at a location opposed to the left-side shaft supporting sleeve 311 with a right-side shaft supporting sleeve 321, having a closed outer end, for supporting a right end of the rotary shaft 41 of the toner stirring and feeding member 40. With the left end of the rotary shaft 41 fitted into the left-side shaft supporting sleeve 311, the right end of the rotary shaft 41 is fitted into the right-side shaft supporting sleeve 321 by warping the rotary shaft 41 slightly, whereby the toner stirring and feeding member 40 is mounted in position inside the toner compartment C of the main cartridge body 30.

The left-side wall 31 of the main cartridge body 30 is formed with a toner inlet 312 at a location above the left-side shaft supporting sleeve 311 for filling the toner T into the toner compartment C. After the toner T is replenished into the toner compartment C, the toner inlet 312 is closed by a cap 313.

The toner stirring and feeding members 40 is rotated by driving forces transmitted from a drive source 102 shown in FIG. 2B to transport the toner T in the toner compartment C to the toner outlet 610 while stirring the toner T.

The toner stirring and feeding member 40 includes the rotary shaft 41 extending in the left and right directions in the toner compartment C, a spiral fin 42 integrally formed with the rotary shaft 41 in coaxial relation therewith to spirally extend on an outer peripheral surface of the rotary shaft 41, a square bar portion 43 integrally formed with the rotary shaft 41 in coaxial relation with the rotary shaft 41 and in the vicinity of the left end of the rotary shaft 41 at the left end thereof, a stirring pad support plate 44 protruding radially from one side of the square bar portion 43 and a stiff sheet-like stirring pad 45 made of synthetic resin having flexibility and affixed to the stirring pad support plate 44.

The square bar portion 43 is formed with flanges 431 at left and right ends thereof. These flanges 431 serve to prevent the joint member 50, mounted on the square bar portion 43, from being displaced left or right. The stirring pad 45 is generally T-shaped with a vertical portion of the T-shape affixed to the stirring pad support plate 44 so that a horizontal portion of the T-shaped stirring pad 45 stirs up the toner T over a wide area.

The rotary shaft 41 is formed with an annular groove 411 at a portion of the left end thereof, which portion extends outward beyond the left-side shaft supporting sleeve 311 when the toner stirring and feeding member 40 is mounted in the main cartridge body 30. A C-ring 412 is fitted in this groove 411 and a packing 413 made of an elastic material like rubber is fitted between the square bar portion 43 of the rotary shaft 41 and the left-side wall 31 of the main cartridge body 30. This packing 413 serves to prevent the toner T in the toner compartment C from leaking to the exterior through the left-side shaft supporting sleeve 311.

The rotary shaft 41 is formed at the left end with a square bar-shaped joint portion 414 which is connected to a specific connecting member of the drive source 102 shown in FIG. 2B when the toner cartridge 20 is mounted in the cartridge compartment Q of the main body 11 (FIGS. 2A and 2B). As the driving force from the drive source 102 is transmitted to the rotary shaft 41 via the joint portion 414, the spiral fin 42 of the toner stirring and feeding member 40 of the rotary shaft 41 rotates in a clockwise direction as seen from the −X direction. As a result, the toner T in the toner compartment C is transported leftward as illustrated in FIGS. 4 to 6 while being stirred up by the rotating stirring pad 45.

The joint member 50 is detachably fitted on the square bar portion 43 of the rotary shaft 41 with the sealing film 70 attached to the joint member 60. The attachment of the sealing film 70 to the joint member 60 is hereinafter referred to as a first mode of sealing film attachment. The joint member 50 is made of an elastic material and includes a rectangular base plate 51 which is elongate in the left and right directions (−X and +X directions) and is brought into tight contact with one side of the square bar portion 43, which side is opposite to the side from which the stirring pad support plate 44 extends, when the joint member 50 is fitted on the square bar portion 43. The joint member 50 also includes four arms 52 projecting from four corners of the base plate 51 to grasp the square bar portion 43, a pair of front and rear clamping plates 53 extending parallel along the left/right directions from front and rear edges of the base plate 51 to clamp the square bar portion 43 therebetween, and a pair of front and rear manipulation tabs 54 extending from the front and rear edges of the base plate 51 in a direction opposite to the direction in which the front and rear clamping plates 53 extend.

Each of the front arms 52 extending from the front edge of the base plate 51 is formed at its free end with an engagement claw 521. Similarly, each of the rear arms 52 extending from the rear edge of the base plate 51 is formed at its free end with an engagement claw 521. The engagement claws 521 of the front arms 52 and the engagement claws 521 of the rear arms 52 face each other in the front and rear directions (−Y and +Y directions). The joint member 50 is mounted on the square bar portion 43 of the toner stirring and feeding member 40 as the arms 52 grasp the square bar portion 43 with the engagement claws 521 engaged with the opposite front and rear edges of the square bar portion 43 extending along the left and right directions.

When the manipulation tabs 54 are elastically deformed from opposite directions with fingers to come close to each other, the base plate 51 elastically deforms into a semicylindrical shape. Correspondingly, the engagement claws 521 of the joint member 50 are disengaged from the square bar portion 43 of the rotary shaft 41 so that the arms 52 can be detached from the square bar portion 43, making it possible to remove the joint member 50 from the square bar portion 43.

The detachable member 60 is so detachably mounted on the bottom 35 of the main cartridge body 30 as to close the mounting opening 350. The detachable member 60 includes a main body 61 having the same radius of curvature as the semicylindrical bottom 35 of the main cartridge body 30 as seen along the left and right directions, a flange 62 formed along a periphery of the main body 61 into a shape that matches the main cartridge body-side flange 37 of the main cartridge body 30, a plurality of hook-like locking parts 63 projecting upward from the flange 62, a claw-like locking part 64 projecting rightward from a right end of the main body 61, and a rim-like wall 65 formed n the main body 61 along the periphery of the main body 61 and projecting upward from the flange 62 to a specific height which is slightly smaller than the thickness of the seal member 80 then mounted in position.

The toner outlet 610 of the main body 61 is formed at a central part thereof in plan view so that the toner outlet 610 can be positioned immediately below the square bar portion 43 of the rotary shaft 41 in the state in which the detachable member 60 is mounted to the main cartridge body 30. The toner T transported leftward in the toner compartment C as a result of actuation of the toner stirring and feeding member 40 is supplied to the developing unit 122 (FIG. 3) through the toner outlet 610, the toner receiving hole formed in the separation plate 18 (FIGS. 2A and 2B) and the toner feeding tube.

The main detachable member body 61 includes a semicylindrical portion 611 which is configured to match the horizontal flange portion 371 of the main cartridge body-side flange 37 and a slant semicylindrical portion 612 which is configured to match the slant flange portion 372 of the main cartridge body-side flange 37. The toner outlet 610 is formed in the semicylindrical portion 611.

The flange 62 includes a horizontal flange portion 621 and a slant flange portion 622 which are configured to fit the horizontal flange portion 371 and the slant flange portion 372 of the main cartridge body-side flange 37, respectively.

In this embodiment, the plurality of hook-like locking parts 63 include a pair of left-side locking parts 631 provided at a left end of the horizontal flange portion 621 of the flange 62 and a pair of right-side locking parts 632 provided face to face in the front and rear directions of the horizontal flange portion 621 of the flange 62.

On the other hand, the horizontal flange portion 371 of the main cartridge body-side flange 37 is formed with a pair of projections 371a projecting in the −Y and +Y directions from the horizontal flange portion 371 at locations corresponding to the respective right-side locking parts 632 of the flange 62. The right-side locking parts 632 are so shaped to hook on the respective projections 371a without interfering with the horizontal flange portion 371 of the main cartridge body 30. Specifically, the length of projection of the right-side locking parts 632 from the horizontal flange portion 621 is determined such that the right-side locking parts 632 can hook on the respective projections 371a without interfering with the horizontal flange portion 371 of the main cartridge body 30.

The semicylindrical bottom 35 of the main cartridge body 30 is formed with a retaining part 353 in the proximity of a lowermost part of the slant flange portion 372. The detachable member 60 is securely mounted on the bottom 35 of the main cartridge body 30 as the claw-like locking part 64 hooks on the retaining part 353.

The sealing film 70 is for sealing off the toner outlet 610 formed in the detachable member 60 and has a rectangular strip shape which is elongate in the front and rear directions (−Y and +Y directions) and has a width in the left and right directions slightly larger than the width of the toner outlet 610 in the left and right directions (−X and +X directions) as illustrated in FIG. 4.

The sealing film 70 of this embodiment includes a sturdy base film 71 made of polyethylene, polypropylene, polyethylene terephthalate or polyamide, for example, and a low-melting plastic layer 72 (shown by small dots in FIG. 4) made of thermoplastic synthetic resin of a low melting point and formed on one surface of the base film 71. In this embodiment, the low-melting resin layer 72 employs ethylene vinyl acetate (EVA) copolymer.

As depicted in FIG. 7A, the sealing film 70 is so attached to the joint member 50 in such a manner that the low-melting resin layer 72 forms a bottom surface of the sealing film 70 which goes into contact with the joint member 50 as will be later described in further detail. With the sealing film 70 so attached to the joint member 50, a first end of the sealing film 70 is so bonded to an inner surface of the main body 61 of the detachable member 60 by heat as to seal the toner outlet 610, with such one end directed rearward (+Y direction). On the other hand, a second end of the sealing film 70 is bonded to a rear surface of the rear clamping plate 53 (+Y direction) of the joint member 50 as illustrated in FIG. 7A by heat. The sealing film 70 is warped at its part between the first and second ends from the front direction (−Y direction) to the rear direction (+Y direction).

It should be recognized that the sealing film 70 may be attached to the joint member 50 and the main body 61 of the detachable member 60 by use of a double-faced tape instead of heat bonding.

When the toner stirring and feeding member 40 is turned clockwise under conditions where the sealing film 70 is attached as described above (FIG. 7A), the sealing film 70 is wound around the joint member 50 as shown in FIG. 7B. In this process, the first end of the sealing film 70 bonded to the inner surface of the main body 61 to seal the toner outlet 610 is peeled away and pulled upward, and eventually wound around the joint member 50 entirely.

On the other hand, the second end of the sealing film 70 bonded to the rear clamping plate 53 of the joint member 50 experiences a shearing force acting parallel to one surface (the low-melting resin layer 72) of the sealing film 70 which surface is attached to the rear clamping plate 53. However, since the second end of the sealing film 70 is attached to the joint member 50 by heat or the use of the double-faced tape, the sealing film 70 is unlikely to be peeled off from the rear clamping plate 53 of the joint member 50 in the direction in which the shearing force acts on the second end of the sealing film 70. It should be appreciated from the foregoing description that the sealing film 70 can easily be peeled when pulled upward (as illustrated) but will not come off easily in the shearing force direction.

When the first end of the sealing film 70 is peeled off from the inner surface of the main body 61, the toner outlet 610 becomes unsealed as shown in FIG. 7B. After the toner outlet 610 is unsealed in this fashion, the sealing film 70 is left wound on the joint member 50.

The seal member 80 to be interposed between the main cartridge body 30 and the detachable member 60 is fitted in the flange 62 of the detachable member 60 beforehand. When the detachable member 60 is mounted to the main cartridge body 30, the seal member 80 is firmly sandwiched between the main cartridge body-side flange 37 and the flange 62 as shown in FIG. 5. Consequently, with the detachable member 60 mounted to the main cartridge body 30, the seal member 80 serves to prevent leakage of the toner T through the contact between the main cartridge body 30 and the detachable member 60.

The seal member 80 of this embodiment is made of high-density micro-cell polyurethane foam. Alternatively, the seal member 80 may be made of an ordinary urethane foam (preferably closed-cell type urethane foam) instead of the high-density micro-cell polyurethane foam. The seal member 80 is shaped slightly smaller than the flange 62 in plan view. Thus, when mounted on the detachable member 60, the seal member 80 is snugly fitted on the outside of the rim-like wall 65, so that the seal member 80 is fitted to the detachable member 60 in a stable fashion.

It is to be noted that the provision of the rim-like wall 65 of the flange 62 is not absolutely necessary. As an alternative, the seal member 80 can be placed between the main cartridge body 30 and the detachable member 60 by attaching the seal member 80 to the flange 62 or the main cartridge body-side flange 37 by means of a double-faced tape, for example. In this case, it is not necessary to make the seal member 80 smaller in shape than the flange 62 in plan view.

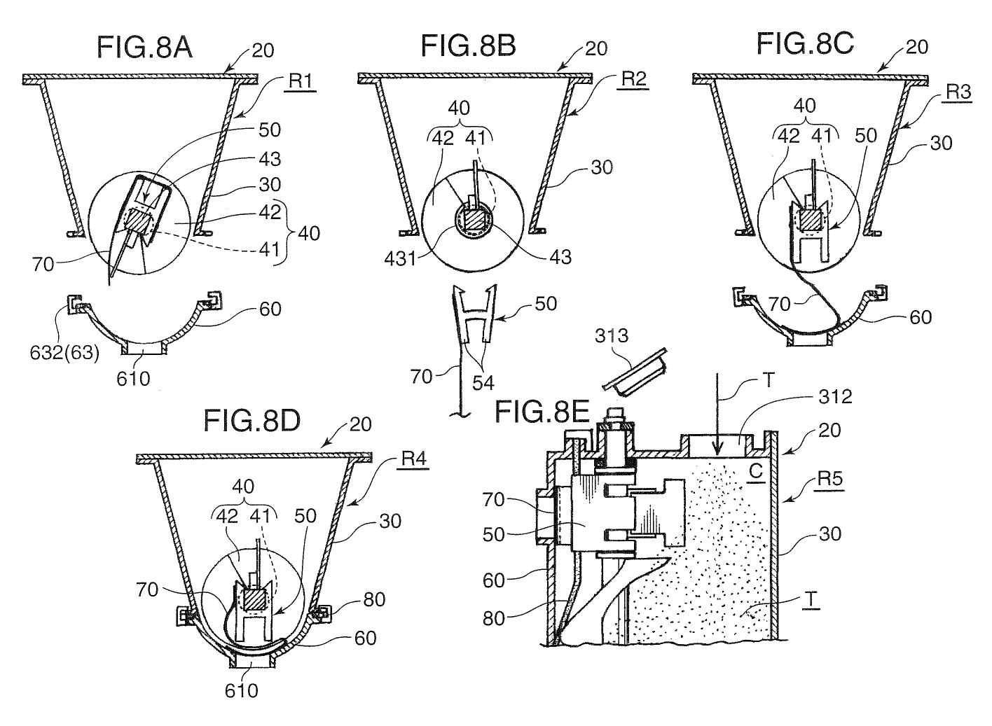

A procedure for recycling a used toner cartridge 20 is now described with reference to FIGS. 8A to 8E which are cross-sectional views for explaining, in particular, how the empty toner cartridge 20 is refilled with the toner T. FIG. 8A shows a detachable member detaching process R1, FIG. 8B shows a sealing film removal process R2, FIG. 8C shows a sealing film attachment process R3, FIG. 8D shows a detachable member mounting process R4 and FIG. 8E shows a toner filling process R5 in cross-sectional views.

In the detachable member detaching process R1, the detachable member 60 is detached from the main cartridge body 30 as shown in FIG. 8A. In this process R1, first, the claw-like locking part 64 (FIG. 6) of the detachable member 60 is pushed upward to disengage the same from the retaining part 353 of the main cartridge body 30. Next, if the detachable member 60 is pulled slightly leftward (to the −X direction), the left-side locking parts 631 are released from the horizontal flange portion 371 of the main cartridge body-side flange 37 and the right-side locking parts 632 come off from the projections 371a of the horizontal flange portion 371. The detachable member 60 is detached from the main cartridge body 30 at this stage. When the detachable member 60 is detached from the main cartridge body 30 in this way, the sealing film 70 still remains wound around the joint member 50.

In the sealing film removal process R2, the joint member 50 is detached from the square bar portion 43 of the rotary shaft 41 as shown in FIG. 8B. The joint member 50 can easily be detached from the square bar portion 43 by pinching the pair of manipulation tabs 54 with fingers from the opposite directions so that the two facing manipulation tabs 54 come close to each other and the distance between the facing engagement claws 521 of the arms 52 of the joint member 50 increases due to elastic deformation of the base plate 51.

Subsequently, the sealing film 70 wound on the joint member 50 detached from the square bar portion 43 is removed. Removal of the sealing film 70 is quite easy because the sealing film 70 is removed after the joint member 50 has been taken out of the main cartridge body 30.

In the sealing film attachment process R3, as shown in FIG. 8C, a first end of a new sealing film 70 is bonded to the inner surface of the main body 61 of the detachable member 60 by heat to seal the toner outlet 610, whereas a second end of the sealing film 70 is bonded to the rear surface (the left surface in FIG. 8C) of the clamping plate 53 of the joint member 50 by heat. Next, the joint member 50 is mounted back on the square bar portion 43. As previously mentioned, the sealing film 70 may be attached to the joint member 50 and the main body 61 by use of a double-faced tape.

In the detachable member mounting process R4, the detachable member 60 is mounted to the main cartridge body 30 as shown in FIG. 8D. More specifically, the detachable member 60 is first held below the main cartridge body 30 at a position slightly offset leftward (−X direction) from the main cartridge body 30 in such a manner that the flange 62 and the main cartridge body-side flange 37 are positioned face to face with the seal member 80 placed therebetween. Then, the detachable member 60 is moved rightward by a small distance so that the hook-like locking parts 63 of the detachable member 60 catch the main cartridge body-side flange 37 (with the right-side locking parts 632 hooked on the projections 371a) and the claw-like locking part 64 of the detachable member 60 becomes engaged with the retaining part 353 provided on the main cartridge body 30. The detachable member mounting process R4 makes it possible to prevent the occurrence of such a problem that the sealing film 70 peels off from the joint member 50 or the detachable member 60 when the detachable member 60 is mounted on the main cartridge body 30.

Finally, in the toner filling process R5, the toner T is filled into the toner compartment C through the toner inlet 312 opened by removing the cap 313 as shown in FIG. 8E. Since the toner inlet 312 and the detachable member 60 are positioned on the left-side wall 31 of the main cartridge body 30, it is possible to visually inspect through the toner inlet 312, for example, whether the joint member 50 is properly mounted on the square bar portion 43 and whether the sealing film 70 is correctly accommodated in the main cartridge body 30. The toner filling process R5 for refilling the toner T into the toner compartment C is completed by fitting the cap 313 in the toner inlet 312.

With the detachable member 60 mounted on the main cartridge body 30, the seal member 80 is interposed between the main cartridge body 30 and the detachable member 60. This configuration helps to effectively prevent leakage of the toner T to the outside from the main cartridge body 30.

Furthermore, in the foregoing embodiment, the second end of the sealing film 70 has been described as attached to the joint member 50. Alternatively, the second end of the sealing film 70 may be attached to a member other than the detachable member 60 which is mounted inside the main cartridge body 30.

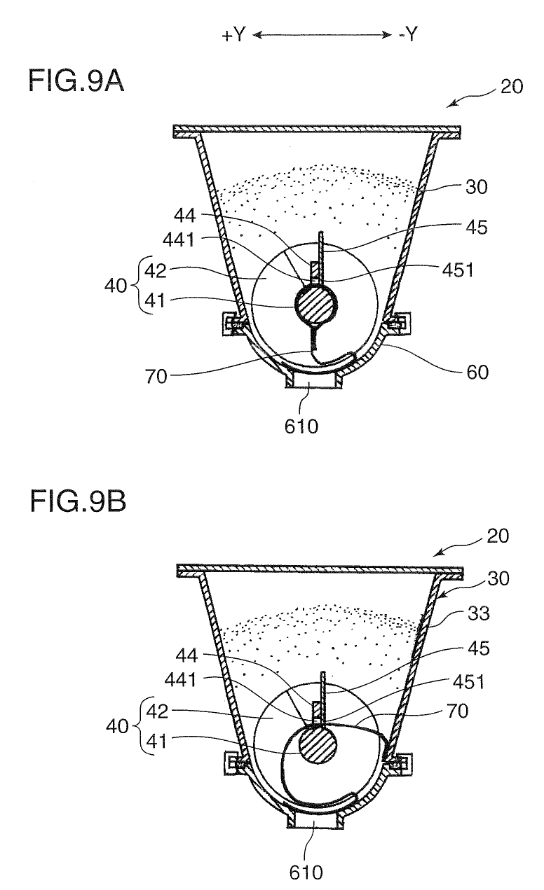

FIGS. 9A and 9B are cross-sectional views for explaining alternative arrangements of attaching the sealing film 70, FIG. 9A showing a second mode of sealing film attachment in which the second end of the sealing film 70 is wound around the rotary shaft 41 of the toner stirring and feeding member 40 and FIG. 9B showing a third mode of sealing film attachment in which the second end of the sealing film 70 is attached to the front wall 33 of the main cartridge body 30. In FIGS. 9A and 9B, the −Y and +Y directions indicate the front and rear directions of the printer 10, respectively, as in FIGS. 1A and 1B.

In the second mode of sealing film attachment, the joint member 50 used in the first mode of sealing film attachment is not provided as shown in FIG. 9A. The rotary shaft 41 of the toner stirring and feeding member 40 is formed with the stirring pad support plate 44 projecting from the rotary shaft 41 in a radial direction and the stirring pad 45 is affixed to the stirring pad support plate 44. The arrangement of the second mode of sealing film attachment differs from that of the first mode of sealing film attachment in that the stirring pad support plate 44 has a support plate-side through-hole 441 formed at a base thereof (i.e., a boundary portion of the stirring pad support plate 44 adjacent to the rotary shaft 41) for passing the sealing film 70 while the stirring pad 45 has a stirring pad-side through-hole 451 similarly formed at a position corresponding to the through-hole 441.

The second end of the sealing film 70 is passed through the two through-holes 441, 451, and is wound directly around the rotary shaft 41 and bonded to the rotary shaft 41 by heat, whereby the sealing film 70 is integrally attached to the rotary shaft 41.

According to this second mode of sealing film attachment, the sealing film 70 is wound up on the rotary shaft 41 when the rotary shaft 41 rotates clockwise as illustrated in FIG. 9A under conditions where the second end of the sealing film 70 is attached to the rotary shaft 41 as described above with the first end of the sealing film 70 attached to the detachable member 60 and sealing the toner outlet 610. In this process of taking up the sealing film 70 onto the rotary shaft 41, the first end of the sealing film 70 bonded to the inner surface of the main body 61 to seal the toner outlet 610 is peeled away from the front direction (−Y direction) to the rear direction (+Y direction), thus opening the toner outlet 610 entirely.

The arrangement of the third mode of sealing film attachment does not employ the joint member 50 either. As shown in FIG. 9B, the arrangement of the third mode of sealing film attachment is the same as that of the second mode of sealing film attachment in that the stirring pad support plate 44 to which the stirring pad 45 is affixed is provided on the rotary shaft 41 and that the support plate-side through-hole 441 and the stirring pad-side through-hole 451 are formed in the stirring pad support plate 44 and the stirring pad 45, respectively.

According to the third mode of sealing film attachment, the first end of the sealing film 70 is bonded to the main body 61 by heat to seal the toner outlet 610 whereas the second end of the sealing film 70 is passed through the two through-holes 441, 451 frontward (−Y direction) and attached to a lower end of the front wall 33 by a double-faced tape as illustrated in FIG. 9B. The sealing film 70 is not attached to the rotary shaft 41 in this third mode.

According to this third mode of sealing film attachment, when the rotary shaft 41 is rotated clockwise with the first end of the sealing film 70 sealing the toner outlet 610, the sealing film 70 passed through the stirring pad-side through-hole 451 in the stirring pad 45 is subjected to a tension exerted in the clockwise direction by the stirring pad 45. Due to this tension, the first end of the sealing film 70 attached to the inner surface of the main body 61 to seal the toner outlet 610 is peeled away from front (−Y direction) to rear (+Y direction), thus opening the toner outlet 610 entirely.

It is to be noted that, in the second and third modes, if the stirring pad 45 is affixed to the stirring pad support plate 44 at a position slightly offset from the base of the stirring pad support plate 44, it is not necessary to form the stirring pad-side through-hole 451 in the stirring pad 45.

As described above, the toner cartridge 20 according to the embodiment of the invention is detachably installed in the main body 11 of the printer (image forming apparatus) 10 for supplying the toner to the developing unit 122. As so far discussed in detail, the toner cartridge 20 includes the main cartridge body 30 provided with the built-in toner stirring and feeding member 40 having the rotary shaft 41 which rotate about a longitudinal axis thereof for stirring up the toner T, the detachable member 60 having the toner outlet 610 formed therein and detachably mounted to the bottom opening 350 formed therein, and the sealing film 70 for sealing the toner outlet 610 with the first end of the sealing film 70 bonded to the detachable member 60 and the second end bonded to a part of the main cartridge body 30. Since the attachment (bonding) of the first end to the detachable member 60 is set to be weaker than the attachment (bonding) of the second end to a part of the main cartridge body 30, the first end of the sealing film 70 attached to the detachable member 60 is peeled off when the joint member 50 rotates together with the rotary shaft 41.

According to the above feature, since the attachment (bonding) of the first end to the detachable member 60 is set to be weaker than the attachment (bonding) of the second end to a part of the main cartridge body 30, the first end of the sealing film 70 attached to the detachable member 60 is peeled off when the joint member 50 rotates together with the rotary shaft 41, as stated above. The toner outlet 610 in the detachable member 60 is opened in this way. As a consequence, the toner T in the toner cartridge 20 is supplied to the developing unit 122 through the toner outlet 610 in the detachable member 60 while being stirred up by the rotating shaft 41. The toner T so supplied is then used for image forming operation performed by the image forming section 12 of the printer 10.

Also, the detachable member 60 is detachably mounted to the bottom opening 350 formed therein. Therefore, when the toner T in the toner cartridge 20 has been used up and the toner T is to be replenished in the empty toner cartridge 20 for reuse thereof, the detachable member 60 is detached from the main cartridge body 30, so that one can visually observe the inside space of the main cartridge body 30 and insert a finger or an appropriate tool into the main cartridge body 30 through the mounting opening 350. This makes it possible to easily remove and replace the sealing film 70 left in the main cartridge body 30 with a new one.

Since the toner cartridge 20 includes the main cartridge body 30 and the detachable member 60 detachably mounted on the main cartridge body 30 as discussed above, it is possible to easily remove the detachable member 60 from the main cartridge body 30 and replace the sealing film 70 left in the main cartridge body 30 with a new one for reuse of the toner cartridge 20 after replenishing the toner T. This configuration of the embodiment facilitates and promotes recycling of the toner cartridge 20, eventually contributing in effect to the protection of the Earth's environment.

Additionally, the rotary shaft 41 of the toner stirring and feeding member 40 is fitted with the integrally rotatable joint member 50 and the first end of the sealing film 70 is attached to the inner surface of the main body 61 to close the toner outlet 610 while the second end is attached to the joint member 50 in the toner cartridge 20. This configuration makes it possible to easily replace the sealing film 70 with a new one when recycling the toner cartridge 20 by bonding the second end of the new sealing film 70 to the detached joint member 50 and mounting again the joint member 50 to the rotary shaft 41.

Furthermore, in the foregoing embodiment, the rotary shaft 41 of the toner stirring and feeding member 40 is provided with the square bar portion 43 and the joint member 50 has the two pairs of facing arms 52 for grasping the square bar portion 43 and one pair of manipulation tabs 54 facing each other from opposite directions and extending in the direction opposite to the arms 52. This configuration makes it possible to remove the joint member 50 from the rotary shaft 41 by simply pinching the manipulation tabs 54 in such a way that the facing manipulation tabs 54 come closer to each other, causing the joint member 50 to elastically deform.

The mounting of the joint member 60 to the square bar portion 43 is also carried out easily. Free ends of the facing arms 52 of the joint member 50 are spaced apart when the facing manipulation tabs 54 are forced closer to each other from the opposite directions by fingers. With the arms 52 space apart, the joint member 50 can be mounted on the square bar portion 43 by holding the same at a position where the facing arms 52 bestride the square bar portion 43 of the rotary shaft 41 and, then, releasing the joint member 50 so that the manipulation tabs 54 return to original positions and the joint member 50 mounts on the rotary shaft 41 with the two pairs of facing arms 52 holding the square bar portion 43 in between.

As the joint member 50 is provided with the arms 52 and the manipulation tabs 54 as discussed above, it is possible to mount and remove the joint member 50 on and from the rotary shaft 41 using only one hand. This structure improves handling with respect to mounting and removal of the sealing film 70 on and from the rotary shaft 41.

Furthermore, in the foregoing embodiment, the seal member 80 is interposed between the main cartridge body 30 and the detachable member 60, making it possible to prevent leakage of the toner T to the outside from the toner compartment C when the detachable member 60 is mounted on the main cartridge body 30.

Moreover, in the foregoing embodiment, the mounting opening 350 of the main cartridge body 30 is bounded by the main cartridge body-side flange 37 and the detachable member 60 is provided with the hook-like locking parts 63. The locking parts 63 are shaped to lock onto the main cartridge body-side flange 37 when the detachable member 60 positioned to face the mounting opening 350 is slid in a specific direction.

According to this configuration, the detachable member 60 is initially held such that the hook-like locking parts 63 thereof are located against the main cartridge body-side flange 37 and is then moved to the main cartridge body 30 in such a way that the hook-like locking parts 63 move toward the main cartridge body-side flange 37 and lock onto the main cartridge body-side flange 37. As a result, the detachable member 60 is securely joined to the main cartridge body 30 so that the detachable member 60 will not come off or loosen unexpectedly.

Since the detachable member 60 is mounted on the bottom of the main cartridge body 30 by pushing the detachable member 60 by a small distance corresponding to the amount of projection of the main cartridge body-side flange 37, it is possible to minimize adverse influence on the sealing film 70 bridging the main cartridge body 30 and the detachable member 60. More specifically, this configuration prevents the occurrence of such a problem that the sealing film 70 peels off from the main cartridge body 30 or the detachable member 60 when the detachable member 60 is mounted on the main cartridge body 30.

The toner cartridge 20 of the present invention is configured to permit recycling by the aforementioned easy procedure. As previously described, the cartridge recycling procedure includes the detachable member detaching process R1 of detaching the detachable member 60 from the main cartridge body 30, the sealing film removal process R2 of removing the sealing film 70 from the main cartridge body 30 through the mounting opening 350, the sealing film attachment process R3 of attaching the first end of a new sealing film 70 to the detachable member 60 and the second end to a part of the main cartridge body 30, the detachable member mounting process R4 of mounting the detachable member 60 to the main cartridge body 30, and the toner filling process R5 of refilling the toner T into the main cartridge body 30.

Particularly since the detachable member 60 is detached from the main cartridge body 30 in the process R1, it is possible to carry out the following processes R2 to R5 smoothly and efficiently, thus enabling a reduction in cartridge recycling cost.

It should be recognized that the present invention is not limited to the foregoing embodiment but includes various modifications and variations thereof as described hereinbelow, for example.

While the foregoing discussion has shown the printer 10 as an example of the image forming apparatus provided with the toner cartridge 20 according to the preferred embodiment, the image forming apparatus is not limited to the printer 10 but may be a copying machine or a facsimile machine, for example.

In the toner filling process R5 of the preferred embodiment, a replacement sealing film 70 is attached to the detachable member 60 which has been detached from the main cartridge body 30. Instead of replacing the sealing film 70 alone, a new or previously used detachable member 60 having a new sealing film 70 attached thereto may be prepared in advance for quick replacement so that the detachable member 60 with the sealing film 70 can be replaced in a timely manner whenever needed. This approach makes it possible to carry out the cartridge recycling procedure with improved working efficiency.

In the foregoing embodiment, the sealing film 70 is bonded to the joint member 50 by heat. Instead of using the above-described arrangement, the sealing film 70 may be attached to the joint member 50 by mounting the joint member 50 onto the square bar portion 43 with part of the sealing film 70 fitted between the joint member 50 and the square bar portion 43 at an appropriate location so that the sealing film 70 will not easily come off the joint member 50.

In the foregoing embodiment, the toner cartridge 20 supplies the toner T to the developing unit 122 through the toner feeding tube. Instead of using this arrangement, the printer 10 may be configured such that the toner cartridge 20 is mounted directly on the developing unit 122 without using the toner feeding tube.

While the present specification has so far described various arrangements of the invention with reference to the preferred embodiment and variations thereof, principal arrangements and features of the invention are summarized hereinbelow.

In an important feature of the invention, a toner cartridge filled with toner includes a main cartridge body having a housing formed with an opening and also having a rotary shaft supported by the housing for rotation about an axis thereof, a detachable member mounted to the opening and having a toner outlet through which the toner is discharged and a sealing film having a first end so attached to the detachable member as to close the toner outlet and a second end attached to a part of the main cartridge body, the first end of the sealing film being peeled off from the detachable member by the rotation of the rotary shaft.

According to the above feature, if the detachable member is detached from the part of the main cartridge body, one can visually observe the inside space of the main cartridge body and insert a finger or an appropriate tool into the main cartridge body through the opening. This makes it possible to easily remove and replace the sealing film left in the main cartridge body with a new one.

In another important feature of the invention, a toner refilling method for refilling toner in a used toner cartridge of the invention configured as stated above includes the step of detaching the detachable member from the main cartridge body, the step of removing the sealing film left in the main cartridge body through the opening, the step of preparing a replacement detachable member to which a first end of a new sealing film is attached, the step of attaching a second end of the new sealing film to a part of the main cartridge body, the step of mounting the replacement detachable member to the main cartridge body; and the step of filling the toner in the main cartridge body.

According to this toner refilling method of the invention, the used toner cartridge can be recycled by mounting to the main cartridge body the replacement detachable member to which the first end of a new sealing film is already attached, after affixing the second end portion of the new sealing film to a part of the main cartridge body. Since the used toner cartridge can be reassembled by this simple recycling procedure, it is possible to promote recycling of toner cartridges at reduced recycling cost.

In the preferred embodiment, the part of the main cartridge body to which the second end of the sealing film is attached may be the rotary shaft or may be an inner surface of the housing.

In the preferred embodiment, the toner cartridge further includes a joint member detachably mounted on the rotary shaft and rotatable together with the rotary shaft. The second end of the sealing film may be attached to the joint member. According to this configuration, it is possible to easily attach the second end of the sealing film to the main cartridge body.

In the preferred embodiment, the attachment of the first end of the sealing film to the detachable member is set to be weaker than the attachment of the second end to the main cartridge body. According to this feature, the first end of the sealing film attached to the detachable member is peeled off when the rotary shaft rotates. As a result, the toner outlet is unsealed, making it possible to supply the toner to the developing unit through the toner outlet.

In the preferred embodiment, the joint member is an elastically deformable member capable of being elastically deformed to be detachably mounted on the rotary shaft. This configuration makes it possible to easily mount and detach the joint member to and from the rotary shaft.

In the preferred embodiment, the toner cartridge further includes a seal member interposed between the main cartridge body and the detachable member. According to this configuration, the seal member serves to prevent leakage of the toner to the outside from the toner cartridge.

In the preferred embodiment, the main cartridge body has a box-like structure and the opening is formed in a bottom of one end of the main cartridge body. According to this configuration, it is possible to discharge the toner from the main cartridge body through the toner outlet primarily by gravitational effect, so that the toner can be supplied to the developing unit with a simple mechanical arrangement.

In the preferred embodiment, the opening in the main cartridge body and the detachable member have flanges formed along respective peripheries, and one of the flanges is formed with a hook-like locking part that is shaped to engage the other flange when the detachable member is moved in a predetermined direction relative to the opening in the main cartridge body. According to this configuration, the detachable member can be fixed to the main cartridge body with a simple mechanical arrangement, making it possible to minimize the risk of unexpectedly peeling the first and second ends of the sealing film from the detachable member and the main cartridge body, respectively, before use of the toner cartridge.

In the preferred embodiment, one end of the main cartridge body is formed with a toner inlet through which the toner is filled into the main cartridge body. This arrangement makes it possible to observe the inside space of the main cartridge body and visually inspect how the sealing film is accommodated therein through the toner inlet.

In the preferred embodiment of the toner refilling method, the step of preparing includes bonding the first end of the new sealing film to the replacement detachable member by heat. Compared to other methods of fixing the first end of the sealing film to the removable cover by, for example, screwing or riveting, the bonding of the first end of the sealing film to the detachable member can be carried out with greater ease.

This application is based on Japanese patent application serial no. 2007-085604, filed in Japan Patent Office on Mar. 28, 2007, the contents of which are hereby incorporated by reference.

Although the present invention has been fully described in connection with the preferred embodiments thereof with reference to the accompanying drawings which are used only for the purpose of illustration, those skilled in the art will readily conceive numerous changes and modifications within the framework of obviousness upon the reading of the specification herein presented of the present invention. Accordingly, such changes and modifications are, unless they depart from the scope of the present invention as delivered from the claims annexed hereto, to be construed as included therein.

What is claimed is:

1. A toner cartridge filled with toner comprising:
a main cartridge body including a housing having an opening formed therein, and a rotary shaft supported by the housing for rotation about an axis thereof;
a detachable member mounted to the opening and having a toner outlet through which the toner is discharged; and
a sealing film having a first end so attached to the detachable member as to close the toner outlet and a second end attached to a part of the main cartridge body, the first end of the sealing film being peeled off from the detachable member by the rotation of the rotary shaft.

2. The toner cartridge according to claim 1, wherein said part of the main cartridge body is the rotary shaft.

3. The toner cartridge according to claim 1, wherein said part of the main cartridge body is an inner surface of the housing.

4. The toner cartridge according to claim 1 further comprising a joint member detachably mounted on the rotary shaft and rotatable together with the rotary shaft; and
wherein said part of the main cartridge body is the joint member.

5. The toner cartridge according to claim 1, wherein the attachment of the first end of the sealing film to the detachable member is set to be weaker than the attachment of the second end to the main cartridge body.

6. The toner cartridge according to claim 4, wherein the joint member is an elastically deformable member capable of being elastically deformed to be detachably mounted on the rotary shaft.

7. The toner cartridge according to claim 1 further comprising a seal member interposed between the main cartridge body and the detachable member.

8. The toner cartridge according to claim 1, wherein the main cartridge body has a box-like structure and the opening is formed in a bottom of one end of the main cartridge body.

9. The toner cartridge according to claim 8, wherein the opening in the main cartridge body and the detachable member have flanges formed along respective peripheries; and
wherein one of the flanges is formed with a hook-like locking part that is shaped to engage the other flange when the detachable member is moved in a predetermined direction relative to the opening in the main cartridge body.

10. The toner cartridge according to claim 8, wherein said one end of the main cartridge body is formed with a toner inlet through which the toner is filled into the main cartridge body.

11. A toner refilling method for refilling toner in the toner cartridge recited in claim 1, the toner refilling method comprising the steps of:
detaching the detachable member from the main cartridge body;
removing the sealing film left in the main cartridge body through the opening;
preparing a replacement detachable member to which a first end of a new sealing film is attached;
attaching a second end of the new sealing film to a part of the main cartridge body;
mounting the replacement detachable member to the main cartridge body; and
filling the toner in the main cartridge body.

12. The toner refilling method according to claim 11, wherein the step of preparing includes bonding the first end of the new sealing film to the replacement detachable member by heat.

13. An image forming apparatus comprising:
an image forming section for forming a toner image based on image data and transferring the toner image onto a recording medium;
a fixing section for fixing the toner image transferred on the recording medium;
a toner feeding section having a toner cartridge for storing toner and supplying the toner to the image forming section, the toner cartridge including:
a main cartridge body having a housing formed with an opening and also having a rotary shaft supported by the housing for rotation about an axis thereof;
a detachable member mounted to the opening and having a toner outlet through which the toner is discharged; and
a sealing film having a first end so attached to the detachable member as to close the toner outlet and a second end attached to a part of the main cartridge body, the first end of the sealing film being peeled off from the detachable member by the rotation of the rotary shaft.

14. The image forming apparatus according to claim 13, wherein said part of the main cartridge body is the rotary shaft.

15. The image forming apparatus according to claim 13, wherein said part of the main cartridge body is an inner surface of the housing.

16. The image forming apparatus according to claim 13, wherein the toner cartridge further includes a joint member detachably mounted on the rotary shaft and rotatable together with the rotary shaft; and
wherein said part of the main cartridge body is the joint member.

17. The image forming apparatus according to claim 13, wherein the attachment of the first end of the sealing film to the detachable member is set to be weaker than the attachment of the second end to the main cartridge body.

18. The image forming apparatus according to claim 16, wherein the joint member is an elastically deformable member capable of being elastically deformed to be detachably mounted on the rotary shaft.

19. The image forming apparatus according to claim 13, wherein the toner cartridge further includes a seal member interposed between the main cartridge body and the detachable member.

20. The image forming apparatus according to claim 13, wherein the main cartridge body has a box-like structure and the opening is formed in a bottom of one end of the main cartridge body.

21. The image forming apparatus according to claim 20, wherein the opening in the main cartridge body and the detachable member have flanges formed along respective peripheries; and
wherein one of the flanges is formed with a hook-like locking part that is shaped to engage the other flange when the detachable member is moved in a predetermined direction relative to the opening in the main cartridge body.

22. The image forming apparatus according to claim 20, wherein said one end of the main cartridge body is formed with a toner inlet through which the toner is filled into the main cartridge body.
